(19) United States
(12) Patent Application Publication
(10) Pub. No.: US 2022/0314049 A1
(43) Pub. Date: Oct. 6, 2022

(54) DEVICE FOR ASSISTING THE MANOEUVRES OF AT LEAST ONE PIPE

(71) Applicant: Abdelbast Boukhili, Saint Xandre (FR)

(72) Inventor: Abdelbast Boukhili, Saint Xandre (FR)

(21) Appl. No.: 17/624,696

(22) PCT Filed: Jul. 2, 2020
(86) PCT No.: PCT/EP2020/068666

§ 371 Date: Jan. 4, 2022

(30) Foreign Application Priority Data
Jul. 5, 2019 (FR) 1907526

(51) Int. Cl. A62C 33/04

(52) U.S. Cl. CPC A62C 33/04

(57) ABSTRACT

The invention relates to a device for assisting the maneuvers of a hose, comprising a frame (2), having at least one cradle (20) which has an inner shape with a circular concavity (21) and displacement means (3), characterized in that the concavity (21) of the cradle extends along a circular of an angle beyond 180°.

This invention relates to a device for assisting the maneuvers of at least one hose.

The invention will be more particularly described with regard to maneuvering a fire hose in operation, without being limited to it, and applies to any maneuver of a pressurized hose.

During a fire, firefighters proceed to a given point, usually defined by the command post.

Once the fire truck is in place, the hoses are unrolled from their respective supports by the service personnel. The adapted nozzle is connected to the free end so that it can be used by the firefighter to dispense water with or without additives, in a spray form dispersed depending on the type of nozzle.

The necessary length of hose is deployed, estimated by the operator according to the circumstances.

To provide a rough idea, the diameter of these hoses ranges from 45 to 110 mm in classic operations. These hoses are made of flexible material so that they can be rolled flat when stored and to allow for the bypassing of objects by following the profile of the ground. These hoses are made of complex fabric with reinforcement in order to resist the high operational pressure and to resist temperature and fire.

The other end of the hose is designed to be connected to a pressurized water supply system, generated in a known way by a pump and driven by the truck's engine or by auxiliary means, or to a hydrant of a high pressure system if one exists nearby.

The hose is then ready for use.

As soon as pressure is applied, the hose takes on its shape, with a round cross-section, under the effect of the radial pressure exerted inside the hose. This pressure is maintained due to the counter pressure exerted by the outlet end of the hose, whose diameter is smaller than that of the hose.

Due to the high pressure, the hose becomes much firmer and more difficult to handle, especially when the length of the hose is extended.

The difficulties of maneuvering are related to the stiffness of the hose once under pressure on the one hand, but also and especially due to the weight of the hose on the other hand.

The weight has two consequences, that of conferring an important intrinsic weight making hoisting difficult and that of exerting an important support on the ground because of its weight, thus generating high friction forces.

It can be seen that when the ground has many natural obstacles such as bushes and other rocks, branches, etc., in the woods or rubble in urban areas, the efforts to be exerted are significant, requiring either serious efforts on the part of the operator, sometimes beyond his limits, or of several operators.

In either case, this is not satisfactory because, in the first case, the operator is fatigued to the detriment of the efforts needed for the rest of the operations or, in the second case, personnel are mobilized to the detriment of other functions.

It should also be noted that in the case of certain operations, such as in the petroleum or chemical industry, the equipment may be distant for long periods of time. Therefore, assistance in hauling such hoses is necessary. This is even more true as the hoses increase in diameter, far beyond what is used in classic urban operations.

It is already known that there are maneuvering assistance devices/mobile hose-carrying devices, which severely limit the maneuvering efforts of a hose. Such devices comprise a cradle able to receive in its middle part substantially half of the section of a hose, and provided with clamping means for holding and clamping the hose in the cradle, the cradle being equipped with rolling means for moving the device. However, these devices have clamping means which are complex to implement and are not fast.

The purpose of the invention is therefore to provide a device that does not have the above-mentioned disadvantages, while still remaining safe. Advantageously, the device must also be easily maneuverable on any type of ground, and be able to carry several hoses if necessary.

According to the invention, the device for assisting the maneuvers of a hose comprises a frame with at least one cradle which has an internal shape with a circular concavity, and displacement means, and is characterized in that the concavity of the cradle extends along an arc of the circle of the angle beyond 180°.

The cradle has two free ends (curved due to the extension of the semi-circle) which project towards the inside of the cradle. The distance between the two free ends is less than the diameter of the hose designed to be housed in the cradle.

Thus, this concavity allows the cradle to provide an arched opening whose free ends in the upper plane are facing each other so as to clamp the hose on a circumference beyond 180° in order to be able to hold it in place in the cradle without the need for clamping means.

In particular, the cradle comprises a lower semi-circle of fixed diameter which is extended by two opposite extension parts in an arc of a circle terminating in two opposite free ends, said free ends projecting relative to two respective planes which are orthogonal (vertical) to the (horizontal) diameter of the semi-circle and tangential to the end points of said diameter.

The separation distance between the two free ends is less than the diameter of the semi-circle. The separation distance between the two free ends is therefore less than the diameter of the hose designed to be housed in the cradle.

Thus, the device of the invention provides ease and speed of use with respect to the arrangement of a hose; there is no longer any need for clamping means, as the user pushes the pressurized hose directly into the cradle and it remains held in place.

According to a preferred embodiment, the concavity of the cradle extends along an arc of a circle with an angle of about 240°.

According to one feature, the frame comprises a plurality of cradles arranged adjacently in a horizontal plane in the position of use of the device, so as to carry a plurality of hoses side by side.

In one embodiment, the device comprises a plurality of frames, each having at least one cradle, and the frames being laterally abutted (in a direction perpendicular to the direction of the hoses to be carried and assembled by removable attachment means which preferably comprise, on the one hand, a connecting pin attaching two frames, and on the other hand, two locking ball pins passing through the frames and with the connecting pin at an orthogonal angle to the latter. This has the advantage of being able to be adapted on site in real time in order to provide the user with a device with the appropriate number of cradles for the operations. In addition, the removable ball pin attachment provides simplicity and speed of implementation, which is extremely advantageous in emergency situations. Moreover, the ball pins constitute an attachment that is in no way hindered by the use of gloves, greatly facilitating the use of the device in the field by firefighters.

The device may comprise clamping means to lock the pipe in position in its cradle, in particular the clamping means comprising a flange and a locking system interacting with the frame and preferentially formed by a ball pin. However, these clamping means do not constitute means of primary securing of the pipe in the cradle, this primary securing being achieved by the very shape of the cradle which holds the cradle in position. The main purpose of these clamping means is to hold the hose in place when it is no longer under pressure.

According to another characteristic, the rolling means are attached to the two opposite ends of the frame in planes transverse to the main axis of the frame (axis perpendicular to the height of the frame and perpendicular to the direction of a door hose), raising the frame and with a height greater than the height of the frame.

Preferentially, the rolling means are removable. In this case, the rolling means consist of two wheels attached to each end of the frame, and the device of the invention comprises removable attachment means which are preferably ball pins, each ball pin interacting with the hub of a wheel and a lateral slot of the frame. The removable attachment by ball pins provides simplicity and speed of implementation. In addition, the removability of the wheels makes it possible to abut and assemble several frames to reach the desired number of cradles, and then to reattach the wheels to the end frames.

In an advantageous embodiment, the rolling means are holonomic wheels with tangential rollers.

The device can be motorized, in particular it comprises a brushless motor.

This invention is now described with the aid of illustrative examples only and it in no way limits the scope of the invention, and from the attached illustrations, in which:

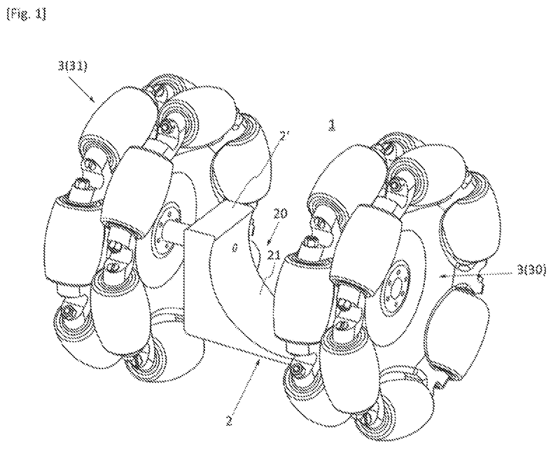

FIG. 1 The present invention is now described with the help of illustrative examples only and in no way limits the scope of the invention, in which: represents a perspective view of an example of an embodiment of the device of the invention for assisting in maneuvers of a hose.

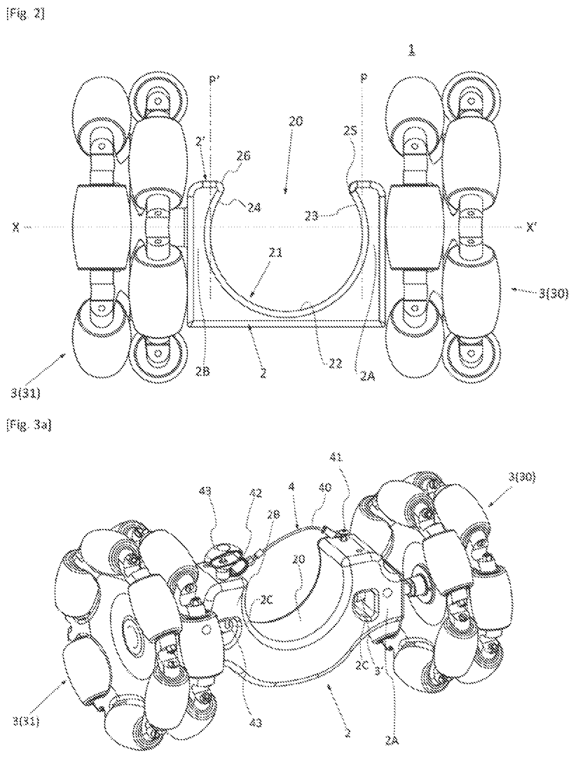

FIG. 2 represents a front view of the device of FIG. 1.

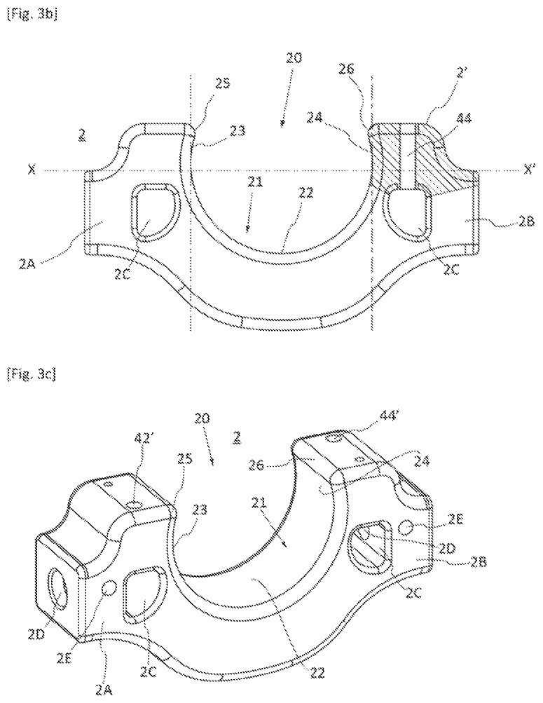

FIG. 3a shows a perspective view of a variant of the device of FIG. 1 additionally showing clamping means.

FIG. 3b is a front view of the frame of the device of FIG. 3a, including a cross section.

FIG. 3c is a perspective view of the frame of the device of FIG. 3a.

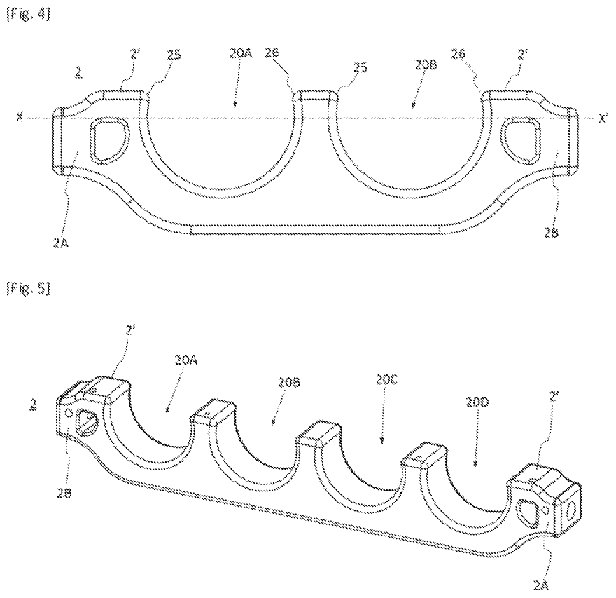

FIG. 4 shows a front view of a variant of the frame with two cradles.

FIG. 5 is a variant of the device with four cradles.

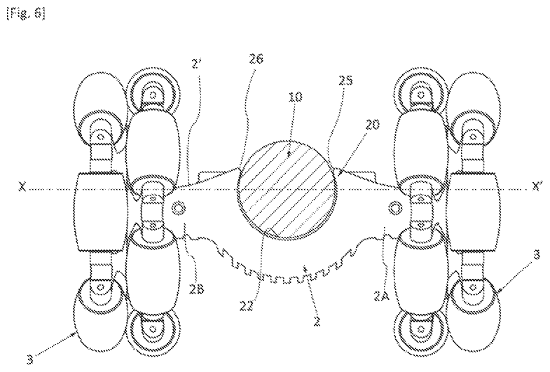

FIG. 6 shows the invention with a hose, the device having a different shape for the lower part of the frame (which does not bring any functional modification), compared to the frame of FIGS. 1 and 3a.

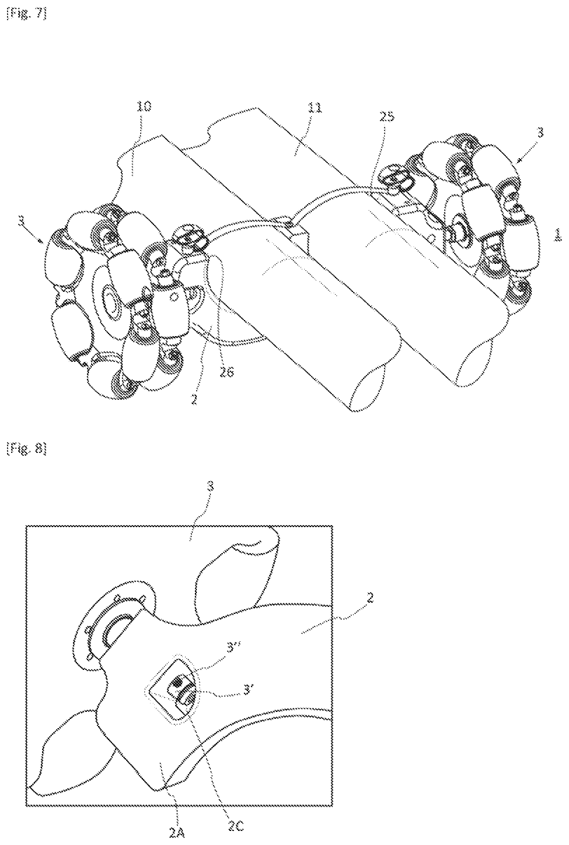

FIG. 7 shows a device according to the invention with a double cradle with two hoses.

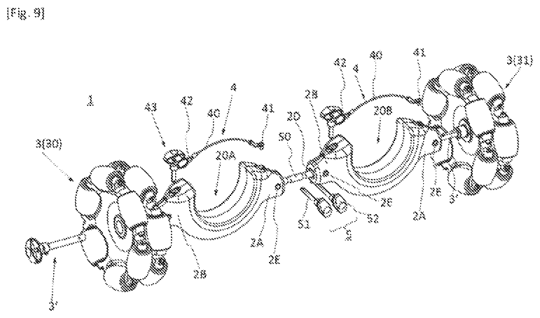

FIG. 8 is a panoramic view showing the removable attachment of a wheel to the frame of the device of the invention.

FIG. 9 is an enlarged perspective view showing a variant of the device by assembling several frames.

The device 1 of the invention for assisting the maneuvers of a hose, illustrated in the figures, is intended to carry and maneuver at least one hose when it is under pressure and is being manipulated, in particular at one of its ends distant from the device. FIG. 6 shows the maneuvering device 1 carrying one hose 10, while the device in FIGS. 7 and 9 is designed to carry two hoses 10 and 11.

As shown in the figures, the maneuvering assistance device 1 comprises a frame 2, at least one cradle 20, displacement means 3, and possibly clamping means 4 (variant of FIG. 3a) intended to lock the hose in position in the cradle. In the variants of FIGS. 4 and 5, the frame 2 comprises several cradles 20A to 20D.

According to the invention, each cradle 20 or 20A to 20D is configured, as will be seen later, to wedge and lock the hose in position when the hose is under pressure without the need for clamping means. Thus, even if the device is positioned so that the cradle is rotated downward while the hose is housed and held in the cradle, the hose will not fall out by gravity. The cradle is designed to hold the hose in place without the need for additional restraining devices. If clamping means 4 are added, they are actually used to keep the hose in a locked position and prevent the hose from being pulled out of its cradle when the hose is no longer under pressure and its diameter has therefore decreased, thus no longer guaranteeing that it will be held in the cradle.

The frame 2 is made of a material resistant to fire or at least to the intense heat of a fire. It is for example made of metal, such as aluminum.

The frame 2 has a longitudinal axis X-X′ which is transverse to the height of the frame and to the longitudinal direction of the hose to be installed in a cradle. The longitudinal axis X-X′ corresponds to or is slightly greater than the axis where the displacement means 3 are attached.

The frame 2 has a superior face 2′, at least one cradle 20 whose outlet opens at the level of the superior face, and two opposite flanges 2A and 2B which are on both sides of the cradle, and to which the displacement means 3 are attached.

The frame 2 comprises a cradle 20, or several adjacent cradles 20A to 20D arranged in alignment with the longitudinal axis X-X′ of the frame.

Each cradle 20 to 20D, which is designed to house a hose, forms a housing with a circular concavity 21, the opening of which is turned upwards in the installed position and ready for use of the device. According to the invention, the circular concavity 21 extends along an arc of a circle whose angle is greater than 180°, preferably about 240° C. Thus, the cradle has a lower semi-circle 22, extending into two opposite extension portions 23 and 24 along the circle of an arc, and ending in two opposite free ends 25 and 26.

The semi-circle 22 of the cradle has a diameter coinciding with the axis X-X′.

The free ends 25 and 26 of the cradle are located above and at a distance from the longitudinal axis X-X′. They are each preferably located at about 30° to the diameter (axis X-X′) of the semi-circle 22. The free ends 25 and 26 form two parts facing each other and projecting from the orthogonal planes P and P′ which are tangential to the circular arc of the cradle, at the end points of the diameter of the lower semi-circle 22. The free ends 25 and 26 are slightly projecting with respect to the planes P and P′ due to the arched angle of the circle 23 and 24 which is only 30°, but sufficient to slightly close the opening of the cradle.

The volume of the cradle is designed to accommodate the pressurized hose without any clearance. The diameter of the cradle is equal to the diameter of the hose. The diameter of the cradle has a diameter at the semi-circle 22 which is intended to accommodate the hose by forcefully inserting the hose from the opening to the bottom 21 of the cradle. This operation by the user is carried out by applying elastic pressure on the hose, the localized deformation being carried out at the level of the hose in order to cross the separation distance between the two curved ends 25 and 26, this distance being smaller than the diameter of the semi-circle 22 and therefore smaller than the diameter of the hose.

Therefore, in the installed position of a hose (FIGS. 6 and 7), the hose is forced slightly into the cradle, its lower part resting on the bottom 21 of the semi-circle 22, the extension parts 23 and 24 with their respective curved ends 25, 26 covering the hose by more than half of its circumference, thus keeping the hose secured.

The cradle intended to be in contact with the hose can be equipped with an anti-slip and/or protective coating. This coating avoids the degradation of the hose and keeps the hose from slipping.

A cradle will be manufactured according to the diameter of the hose intended to be accommodated. The diameter of the cradle's semi-circle will be manufactured according to the existing pipe diameters on the market, for example, but not exhaustively, 45 mm, 70 mm, 110 mm. In particular, a cradle has a cradle that can vary from 10 mm to 300 mm.

When the frame has several adjacent cradles, the cradles may have the same accommodation volume for hoses of the same diameter, or the cradles may have different accommodation volumes to accommodate different hose diameters.

FIG. 3a shows clamping means 4 to lock the hose in position and further secure the device. As a preferred embodiment, the clamping means comprises a flange 40 to which a terminal end 41 is attached, one end of which is firmly attached to the frame 2 on the upper side 2′ of the frame at the level of one of the wings 2A, and the terminal end 42 is removable and interacts by locking with the upper side 2′ of the frame on the other side of the cradle. At the level of the other wing 2B.

The flange 40 is for example a wire cable. The flange 40 covers the opening of the cradle substantially in the X-X′ direction, and preferably comprises a concave shape facing the cradle and is designed to fit the upper part of the pipe which will project from the outlet of the cradle. The flange may also be equipped with a coating on the part of the flange in contact with the hose, so as to avoid any damage to the hose by friction.

The terminal end 42 of the flange comprises a member forming part of, or attached to, a locking system 43. The purpose of the locking system 43 is to lock the flange 40. The locking system 43 is preferably a ball pin. The ball pin 43 is adapted to interact with a vertical passage 44 (FIG. 3b) arranged in the thickness of the wing 2B perpendicularly to the axis X-X′, from the upper face 2′ of the frame and opening into a hollow space 2C of the wing thickness. The balls of the ball pin come into abutment against the wall of the hollow space 2C, which locks the ball pin in position, and locks the flange 40.

In the embodiment shown (FIG. 3c), the points 42′ and 44′ for securing the flange 40 to the upper part 2′ of the frame, via the locking system 43, are diagonally symmetrical. This provides a clamping of the hose in a direction diagonal to the hose axis.

The displacement means 3 are made here in the form of at least two wheels, in this case two wheels 30 and 31, one on each side of the wings of the frame 2, which are free to rotate around the transverse axis X-X′, in this case mounted on two half-shafts attached respectively to the two opposite wings 2A and 2B. We note that the diameter of each wheel is greater than the diameter of the hose intended to be carried with a ground clearance, so as to avoid the friction of the hose on the ground but also to limit the friction of the cradle of the frame on the ground.

The wheels are mounted symmetrically, so that the device can be turned over without any problems. If the hose twists and the device turns over, the wheels come back into contact with the ground and the device can continue to move.

The wheels are preferably removable. With respect to FIGS. 3a, 3c, 8 and 9, the wheels 3 are preferably attached by ball pins 3′, each pin 3′ passing through the hub of a wheel 3 and being inserted in a lateral slot 2D of a wing 2A, respectively 2B, of the frame in order to open into the hollow space 2C of the wing of the frame, the balls 3″ of the pin coming into abutment against the wall of the hollow space, thus locking the attachment of the pin 3′.

The wheels are resistant to fire and/or at least to intense heat. These wheels can be made of rubber, or even metal, for example aluminum, to profit from the inherent lightness of the material.

In a preferred embodiment of the displacement means 3 and as illustrated, the wheels are holonomic wheels with tangential rollers.

It is advantageous that the device of the invention can be motorized, and comprise an electric motor of the brushless type, preferably mounted on a wheel, so as to facilitate the driving of the device and thus of the hose when the hose is pulled.

FIG. 9 shows a further variant of a frame with two cradles. Here, the frame is not designed with a given number of cradles at the time of manufacture, but is the compilation of several single-cradle frames (although each frame could comprise several cradles). This variant has the advantage that the desired number of cradles, in this case two cradles, can be adapted on site for the user by assembling several single-cradle frames adjacent to each other along the X-X′ axis, and by attaching a wheel 3 at both distal ends.

In this embodiment, the maneuvering assistance device 1 comprises removable attachment means 5 for assembling two side-by-side frames 2. The removable attachment means 5 comprise a pin 50 capable of fitting into the lateral slots 2D of the frame wings (normally used for the fitting of the 3′ wheel attachment ball pins 3′), and as a locking means, preferably two ball pins 51 and 52 designed to fit into orifices 2E of the frame wings (also visible in FIG. 3c) and to interact transversely with the pin 50.

The use of the device 1 for assisting the maneuvering of a hose is now described.

After unrolling a hose, connecting said hose to a source of pressurized liquid, and after the hose has been pressurized by said liquid to its operating configuration, the user may position maneuvering aids 1 according to the present invention evenly along the length of said hose.

To do this, the user slides the frame 2 under the hose to position the hose in line with the cradle of the frame after having spread the flange when there is one. He presses hard vertically on the hose to pass the constricted area between the two projecting/curved ends 25 and 26, and pushes the hose into the cradle. The hose is in place and attached without the risk of unintentionally coming out of the cradle.

Alternatively, the hose may have been placed in the cradle before being pressurized. As soon as it is pressurized, it is locked.

For safety, in anticipation of the hose being held in the cradle when it is no longer under pressure, the user can lock the hose in position by having the flange 40 and securing it with the locking system 43.

1. A device for assisting the maneuvers of a hose, comprising a frame (2) provided with at least one cradle (20) which has an inner shape with a circular concavity (21), and displacement means (3), characterized in that the concavity (21) of the cradle extends along an arched angle of a circle beyond 180°.

2. The device according to claim 1, characterized in that the cradle (20) has two free ends (25, 26) which project toward the inside of the cradle (20).

3. The device according to claim 1, characterized in that the cradle (20), comprises a lower semi-circle (22) of fixed diameter which is extended by two opposite extension parts in an arc of a circle (23,24) terminating in two opposite free ends (25, 26), said free ends (25, 26) projecting relative to two respective planes orthogonally to the diameter of the semi-circle (22), and tangential to the end points of the said diameter.

4. The device according to claim 2, characterized in that the separation distance between the two free ends (25, 26) is less than the diameter of the hose designed to be housed in the cradle (20).

5. The device according to claim 1, characterized in that the concavity (21) of the cradle (20) extends along an arc of an angle of about 240°.

6. The device according to claim 1, characterized in that the frame (2) comprises several cradles arranged adjacently in a horizontal plane in the position of use of the device.

7. The device according to claim 1, characterized in that the displacement means (3) are removable and attached to the frame (2) with removable attachment means, preferentially attached by ball pins (3′).

8. The device according to claim 1, characterized in that the displacement means (3) are holonomic wheels and tangential rollers.

9. The device according to claim 1, characterized in that it is motorized, in particular it comprises a brushless motor.

10. The device according to claim 1, characterized in that it comprises several frames (2) each having at least one cradle, the frames (2) being abutted laterally and assembled with removable attachment means (5) which preferentially comprise, on the one hand, a link pin (50) connecting two frames, and on the other hand, two locking ball pins (51, 52) passing through the frames (2) and passing at an orthogonal angle through the link pin (50).

11. The device according to claim 1, characterized in that it comprises clamping means (4) for locking the hose in position in its cradle (20), in particular the clamping means (4) comprising a flange (40) and a locking system (43) interacting with the frame (2) and preferentially formed from a ball pin.

12. A method of using the device according to claim 1, for assisting the maneuvers of at least one fire hose in operation, the said at least one hose being attached to the said at least one cradle (20).
